(19) United States
(12) Patent Application Publication
(10) Pub. No.: US 2015/0353168 A1
(43) Pub. Date: Dec. 10, 2015

(54) METHODS FOR PROTECTING AND REPAIRING OF BOAT HULLS

(71) Applicant: RESODYN CORPORATION, Butte, MT (US)

(72) Inventors: Stephen Lloyd Galbraith, Butte, MT (US); Eduard A. Stefanescu, Butte, MT (US)

(21) Appl. No.: 14/730,995

(22) Filed: Jun. 4, 2015

Related U.S. Application Data
(60) Provisional application No. 62/007,867, filed on Jun. 4, 2014.

(51) Int. Cl. B63B 9/04; B05D 3/02; B63B 9/06; B05D 1/08

(52) U.S. Cl. CPC B63B 9/04; B05D 1/08; B05D 3/0218; B63B 9/06; B63B 2009/008

(57) ABSTRACT

A method for protecting a boat hull is provided. A first polymer thermal spray coating is applied to a surface of a boat hull and to a rigid member. The rigid member is placed at a desired location on the surface of the boat hull. The rigid member is heated such that the first polymer thermal spray coating adhesively bonds the rigid member to the surface of the boat hull.

### CROSS-REFERENCE TO RELATED PATENT APPLICATIONS

This application claims the benefit of and priority to U.S. Provisional Patent Application No. 62/007,867, filed Jun. 4, 2014, the entire disclosure of which is incorporated by reference herein.

### BACKGROUND

The present application relates generally to boat hulls, and in particular, to methods for protecting and repairing boat hulls using a polymer thermal spray (PTS) system.

Generally speaking, various approaches used to protect boat hulls from impact or abrasion occurrences involve the use of mechanical attachments, adhesive attachments, and spray-on coatings. Attachments serve to protect the hull from contact with the impact or abrasive item. Chemical spray-on coatings, such as urethane-based and urea-based coatings (e.g., coatings that may be used as truck bed linings), can be applied to the hull to protect the hull from, for example, abrasion by providing tough and/or slippery surfaces that protect the underlying hull substrate.

However, the above-noted approaches suffer various drawbacks. For example, mechanical attachments, such as bolt-on rub rails, polyethylene sheets, and welded beaching plates, are difficult to service in the field. Moreover, corrosive water (e.g., salt water, etc.) can seep between the attachments and the underlying hull, which may accelerate corrosion of the hull. Adhesive attachments are prone to failure at bond lines and are difficult to repair. Moreover, adhesive attachments have a limited shelf life. Chemical spray-on coatings, such as urethane-based coatings and urea-based coatings, are applied by spraying harsh chemicals (e.g., a two part thermosetting mix, etc.) out of a sprayer. The harsh chemicals are often over-sprayed onto other equipment (e.g., equipment not intended to receive a coating of the chemicals) or into the environment. In addition, the chemicals may ruin the spray applicator equipment, each of which may be cumbersome to clean and repair.

### SUMMARY

In one aspect, the present disclosure relates to a method for protecting a boat hull. A first polymer thermal spray coating is separately applied to a surface of a boat hull and to a rigid member. The rigid member is placed at a desired location on the surface of the boat hull. The rigid member is heated such that the first polymer thermal spray coating adhesively bonds the rigid member to the surface of the boat hull.

In another aspect, the present disclosure relates to a method for protecting a boat hull. A first polymer thermal spray coating is separately applied to a surface of a boat hull and to a rigid member. The rigid member is placed at a desired location on the surface of the boat hull. A second polymer thermal spray coating is applied to both the rigid member and the boat hull to encapsulate the rigid member on the boat hull.

In yet another aspect, the present disclosure relates to a method for repairing a boat hull. The method includes providing a boat hull including a first polymer thermal spray coating with a damaged area. The first polymer thermal spray coating is heated at or near the damaged area to soften the first polymer thermal spray coating. While the first polymer thermal spray coating is still soft, a second polymer thermal spray coating is applied to the damaged area such that the second polymer thermal spray coating melts into and blends with the first polymer thermal spray coating to provide a substantially seamless, integral repair.

### BRIEF DESCRIPTION OF THE DRAWINGS

The above and related objects, features, and advantages of the present disclosure will be more fully understood by reference to the following detailed description, when taken in conjunction with the following figures, wherein:

FIG. 1 is a schematic illustration of a general process for applying a PTS coating to a substrate according to one implementation.

FIGS. 2a-2e illustrate various boat hull geometries including a PTS coating according to various implementations.

FIG. 3 is a photograph of a ¼ inch thick aluminum boat plank that has been perforated in a drop test at an impact energy of about 760 ft-lbs. The figure also contains a photograph of a similar plank that was not perforated in the same drop test because it was coated with a PTS coating according to one implementation.

FIG. 4 is a photograph of a ⅜ inch thick G-10 composite material plank that has been perforated in a drop test at an impact energy of about 460 ft-lbs. The figure also contains a photograph of a similar plank that was not perforated in the same drop test because it was coated with a PTS coating according to one implementation.

FIG. 5 is a flow diagram illustrating a method for protecting a boat hull by bonding and encapsulating a rigid member thereto according to another aspect of the present disclosure.

FIG. 6a is a photograph of a rigid member shown as a strake angle being applied to a boat hull plank according to one implementation.

FIG. 6b is a photograph of the strake angle of FIG. 6a bonded to the boat hull plank and encapsulated by a PTS coating according to one implementation.

FIG. 7 illustrates a rigid member shown as a doubler plate bonded to and encapsulated on a boat hull according to one implementation.

FIG. 8 is a flow diagram illustrating a method for repairing a boat hull according to another aspect of the present disclosure.

FIG. 9a is a photograph of a boat plank including a first PTS coating being reheated and scraped off with a knife to simulate a scraping incident of the boat plank according to one implementation.

FIG. 9b is a photograph of the boat plank of FIG. 9a being repaired by adding a second PTS coating according to another aspect of the present disclosure.

FIG. 9c is a photograph of a dented boat plank that has been repaired by filling in the dent with a PTS coating according to one implementation.

### DETAILED DESCRIPTION

Aspects and implementations of the present disclosure relate to methods using a polymer thermal spray (PTS) coating system that provides for impact and abrasion protection of a substrate, such as a boat hull. In one aspect, a method includes the use of a PTS coating and a PTS application system that, when applied directly to a surface of a boat hull, provides abrasion and impact protection/resistance to the boat hull while mitigating the above-described problems associated with the above-described mechanical attachments, adhesive attachments, and chemical spray-on coating systems. In another aspect, a method includes the use of a PTS coating to bond and encapsulate a rigid member (e.g., a strake angle, a doubler plate (i.e., a “beach plate”), etc.) to a boat hull to provide additional impact and abrasion protection. In yet another aspect, a method includes the use of a PTS coating system to repair a damaged area of an existing PTS coating on a boat hull.

Although the present application focuses primarily on protecting and repairing boat hulls, it is appreciated that the PTS coating can be applied to many other types of substrates, including marine and non-marine substrates. The PTS coating disclosed herein provides a tough, impact resistant, coating that protects the substrate, and is easily repairable and removable in the field. In addition, the PTS coating can be used to bond and encapsulate various rigid members to the substrate to provide additional impact and abrasion protection.

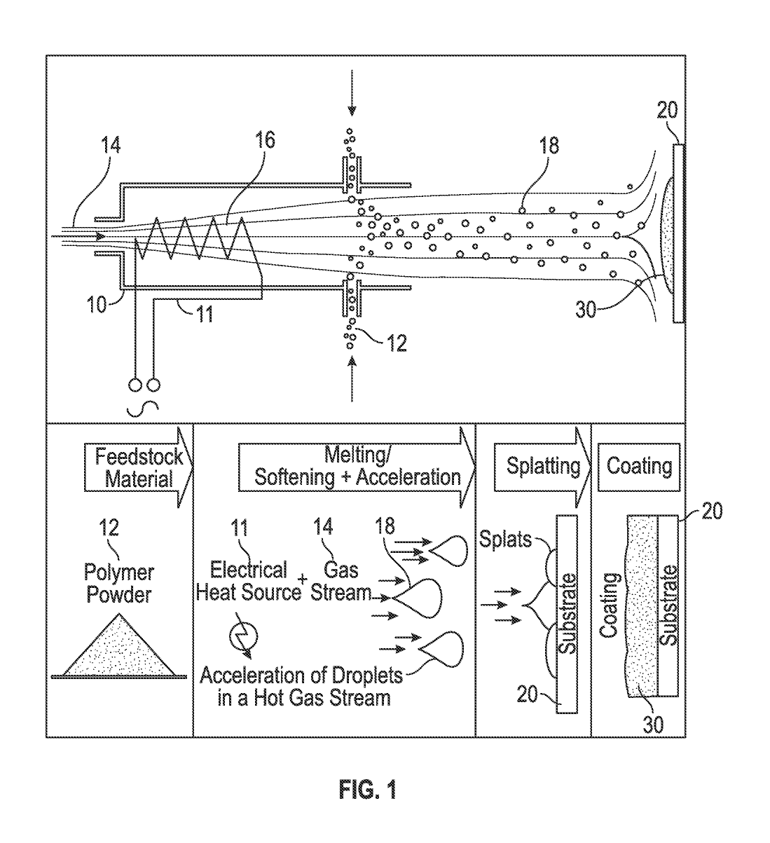

Referring now to FIG. 1, a general process for applying a PTS coating to a substrate (e.g., a boat hull, etc.) is shown schematically according to one implementation. The PTS coating can be applied using, for example, a self-contained, PTS coating application system. The PTS coating application system can be, for example, a 30 kW propane powered system or a small 2 kW electric system. In some implementations, the PTS coating application system may include, among other components, a powdered material storage hopper to provide a powdered material 12 and a hand-held applicator gun 10. In various implementations, the PTS coating application system is mobile to allow for field applications and/or field repairs of, for example, boat hulls.

As shown in the implementation of FIG. 1, a compressed process gas 14, typically air, is heated in a hand-held applicator gun 10 by propane combustion or an electrical heating element 11. The powdered material 12 (i.e., the PTS material) received from the material hopper is fed through, for example, a hose to the applicator gun 10. The powdered material 12 is heated in the gun 10 by the hot process gas 14 or electrical heating element 11. The powdered material 12 is projected towards a target substrate 20, such as a boat hull surface, by the applicator gun 10. As the powdered material 12 is heated and projected towards the target substrate 20, the powdered material 12 at least partially melts such that it becomes a sticky, semi-molten polymer material 18, sufficient to adhere to a surface of the target substrate 20. The sticky, semi-molten material 18 fuses under additional heat provided by the applicator gun 10 into a continuous PTS coating 30 on a surface of the target substrate 20. The PTS coating 30 hardens upon cooling to form a tough, impact resistant, coating that can provide impact and abrasion protection for the target substrate 20. Additionally, as described below, the PTS coating 30 can be used to bond and encapsulate rigid members (e.g., strake angle pieces, doubler plates (i.e., “beach plates”), etc.) to the substrate to provide additional protection to the substrate, and/or can be used to perform field repairs of the coating itself.

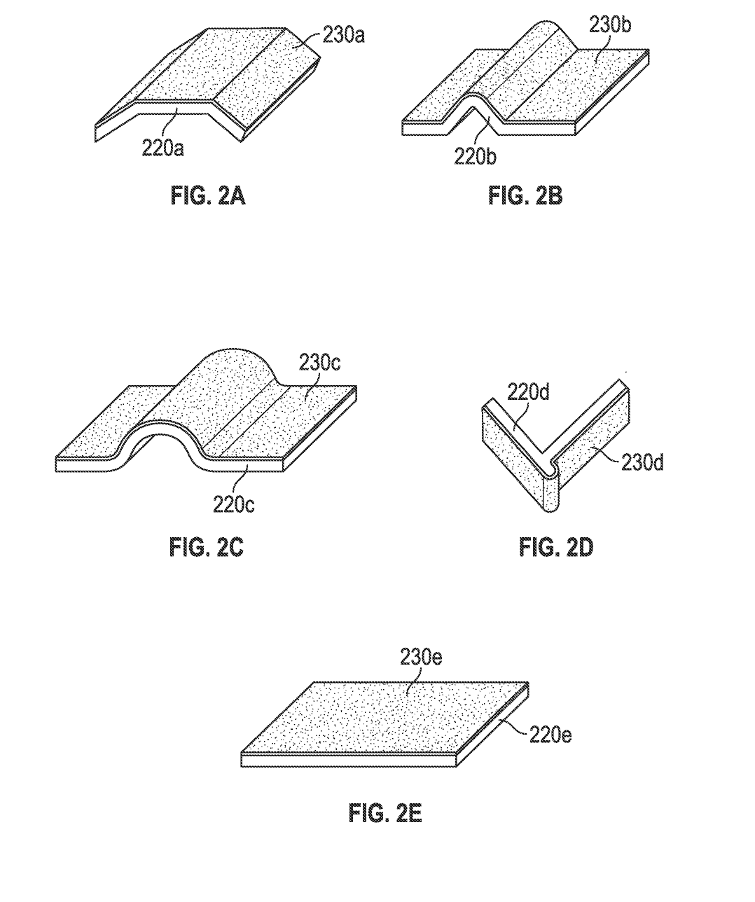

According to one aspect of the present disclosure, a method of applying a PTS coating directly to a surface of a boat hull is provided. In one implementation, the PTS coating is applied directly to a boat hull surface such that the PTS coating bonds to the boat hull and encapsulates the boat hull surface. The applied PTS coating can provide impact and abrasion protection/resistance to the boat hull surface. In some implementations, the boat hull can be made from a material such as aluminum, steel, or a composite material. The PTS coating disclosed herein can bond directly to the boat hull surface and is compatible with each of the above described boat hull materials. In various implementations, the PTS coating can be applied to different boat hull geometries. For example, FIGS. 2a-2e illustrate various boat hull geometries including a PTS coating disposed thereon. As shown in FIGS. 2a-2e, the PTS coating 230 can conform to geometries of a boat hull 220, such as chine bends (FIG. 2a), rub rails or gunwales (FIG. 2b), welded transom corners (FIG. 2c), strake angles (FIG. 2d), and flat hull planks (FIG. 2e) of a boat hull. In addition, the PTS coating can be applied directly to other areas of a boat hull, including the bow, the transom, the plank area, the keel, or the stern of the boat hull (not shown). The PTS coating provides a tough, impact resistant layer on the boat hull to provide impact and abrasion protection. In some implementations, the PTS coating can have a thickness of between about 0.01 inches and about 0.5 inches. In some implementations, the PTS coating can have a thickness of about 0.25 inches.

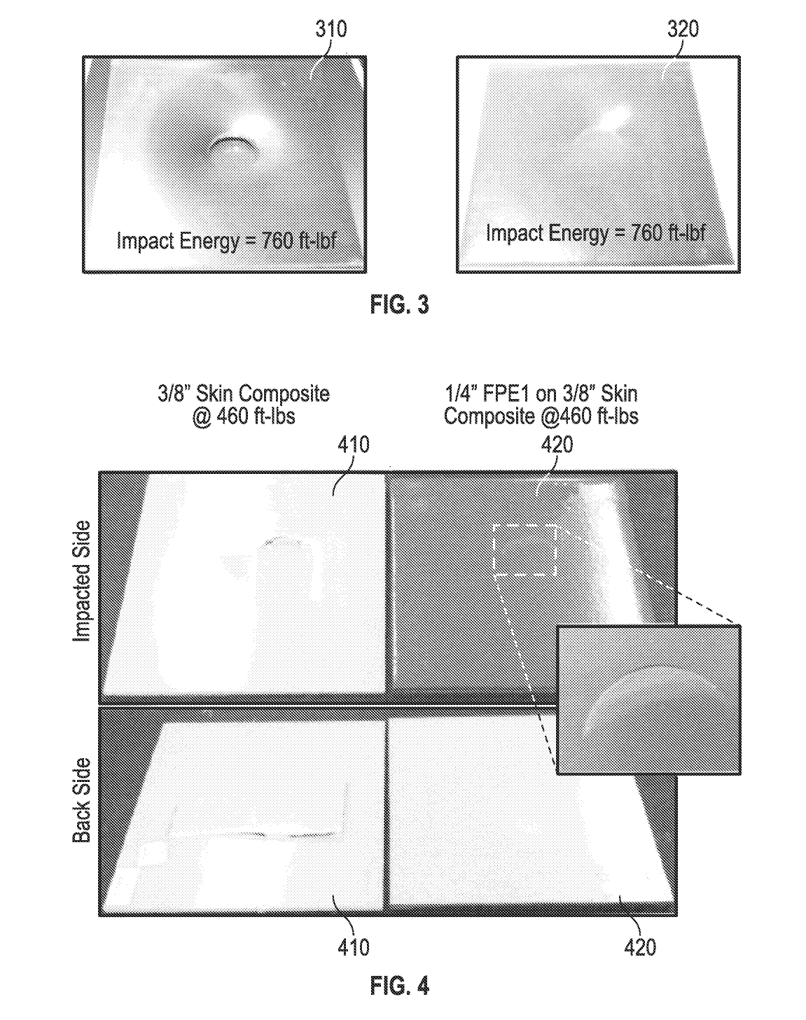

For example, referring to FIG. 3, photographs of a ¼ inch thick plate of 5086 H32 alloy aluminum representative of an aluminum boat hull plank are shown according to one implementation. Plate 320 was coated with about a ¼ inch thick layer of PTS coating material. Plate 310 was not coated with PTS. A steel impact weight having a 2½ inch diameter right circular cylinder (RCC), weighing 38 lbs was dropped from a height of 20 feet onto each of the test plates, imparting about 760 ft-lbs of impact energy to the test plates. The uncoated plate 310 was perforated by the steel impact weight. The PTS coated plate 320, however, was not perforated under the same test conditions. This test demonstrates the ability of the PTS coating to add increased durability against impact events to an aluminum boat hull, such as would be encountered when an aluminum boat hull hits, for example, a rigid object.

Similarly, FIG. 4 illustrates advantages of the PTS coating as it relates to protecting composite boat hulls. In particular, FIG. 4 illustrates photographs of a 3/16 inch thick plate of G-10 glass filled polyester composite representative of a composite boat hull plank. Plate 420 was coated with a about ¼ inch thick layer of PTS coating material. Plate 410 was not coated with PTS. A steel impact weight having a 2½ inch diameter right circular cylinder (RCC), weighing 23 lbs, was dropped from a height of 20 feet onto each of the test plates imparting about 460 ft-lbs of impact energy to the test plates. As shown in FIG. 4, the uncoated plate 410 was perforated by the steel impact weight. By contrast, the PTS coated plate 420 was not perforated under the same test conditions. This test demonstrates the ability of the PTS coating to add increased durability against impact events for composite boat hulls.

According to another aspect of the present disclosure, a method for protecting a boat hull by bonding and encapsulating a rigid member to the boat hull is provided. The method includes the use of a PTS coating to bond and encapsulate a rigid member to a surface of a boat hull to provide abrasion and impact protection to the boat hull. In one implementation, the rigid member is a strake angle. In another implementation, the rigid member is a doubler plate, sometimes referred to as a “beach plate.” In some implementations, the rigid member can be bonded to a keel, a stern, a plank, a bow, a transom corner, or another area of the boat hull.

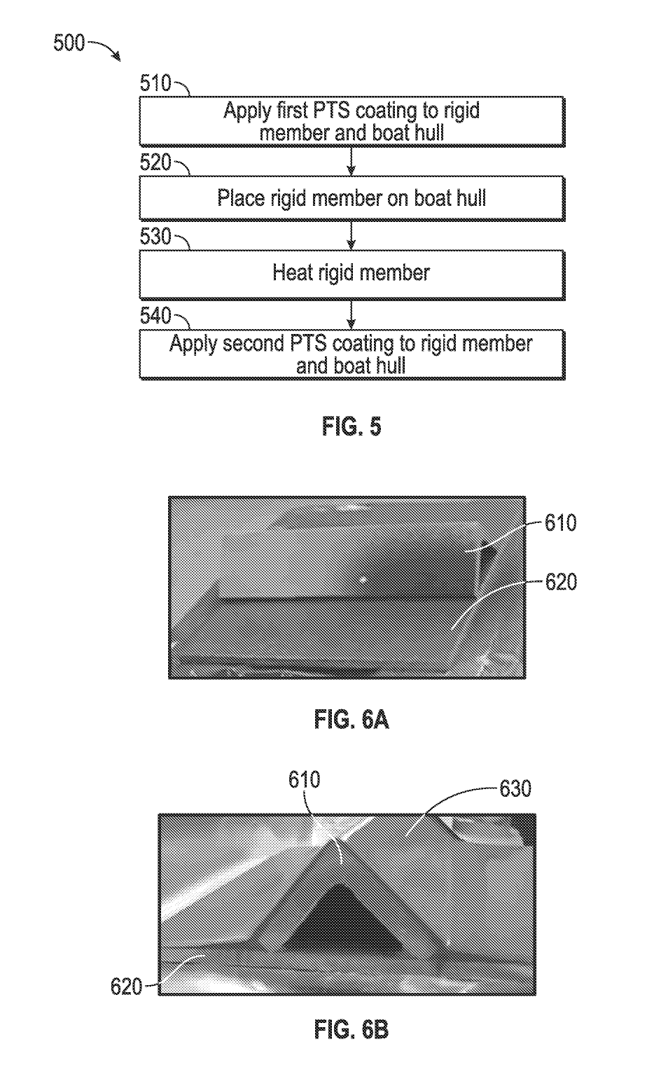

Referring to FIG. 5, a method 500 for protecting a boat hull by bonding and encapsulating a rigid member thereto is shown according to one implementation. A first PTS coating is separately applied to a surface of a boat hull and to a rigid member (step 510). The rigid member is placed at a desired location on the surface of the boat hull such that the first PTS coated surfaces of the rigid member and the boat hull are in contact with each other (step 520). In some implementations, the rigid member (e.g., a doubler plate, etc.) can be placed on the bow or transom corner of the hull before, for example, applying a second PTS coating. The rigid member is heated using, for example, a heat gun, such that the first PTS coating adhesively bonds the rigid member to the boat hull (step 530). A second PTS coating can be applied to both the rigid member and the boat hull to encapsulate the rigid member on the boat hull (step 540). In some implementations, such as when bonding a strake angle to a boat hull, the rigid member is not heated to adhesively bond the strake angle to the boat hull. Instead, the second PTS coating can act to both adhesively bond and encapsulate the strake angle onto the boat hull. In some implementations, at least one of the first and second PTS coatings can have a thickness of between about 0.01 inches and about 0.5 inches. In some implementations, at least one of the first and second PTS coatings can have a thickness of about 0.25 inches.

For example, in one implementation shown in FIGS. 6a-6b, a rigid member shown as a strake angle piece 610 is bonded and encapsulated on a hull plank 620 of a boat hull. FIG. 6a is a photograph of the strake angle piece 610 resting on the hull plank 620 prior to receiving a second PTS coating 630 (shown in FIG. 6b). As shown in FIG. 6a, both the strake angle piece 610 and the hull plank 620 are shown separately coated with a first PTS coating. FIG. 6b shows the same strake angle piece 610 and hull plank 620 after the two pieces have been coated in a second PTS coating 630. The second PTS coating 630 is applied to both the strake angle piece 610 and the hull plank 620 to both bond and encapsulate the strake angle piece 610 on the hull plank 620. The second PTS coating 630 conforms to the strake angle piece 610 and to the hull plank 620. Additionally, the second PTS coating 630 adhesively bonds the strake angle piece 610 to the hull plank 620 and seals the joint between the strake angle piece 610 and the hull plank 620, so as to form a watertight seal therebetween.

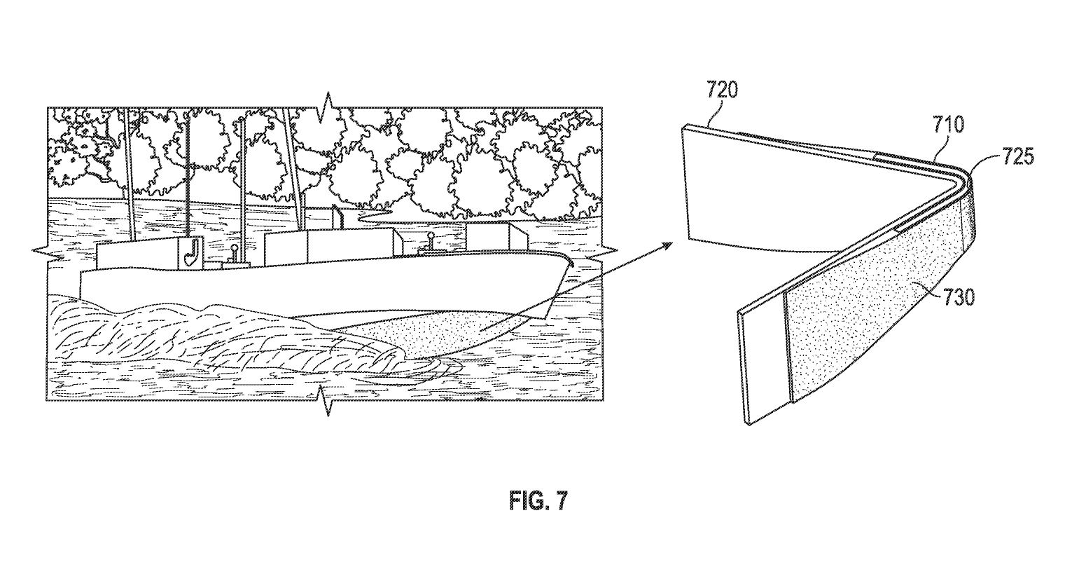

In another implementation shown in FIG. 7, a rigid member shown as a doubler plate 710 is bonded and encapsulated to a boat hull surface 720. As shown in FIG. 7, the boat hull 720 and the doubler plate 710 include a first PTS coating 725. The doubler plate 710 is adhesively bonded to the boat hull 720 via the first PTS coating 725 by, for example, heating the doubler plate 710. A second PTS coating 730 entirely encapsulates the doubler plate 410 relative to the boat hull 720.

Using a PTS coating to adhesively bond and encapsulate a rigid member to a boat hull is particularly advantageous, because the PTS bonded and coated rigid member prevents water from seeping in between the rigid member and the boat hull by creating a watertight seal therebetween. Furthermore, if damage to the rigid member and/or the underlying hull was severe enough to require a metal repair, the PTS material can be easily reheated and removed from the repair area to facilitate further repair. For example, a new metal patch plate could be welded onto the repair section and then re-encapsulated with PTS coating material. Alternatively, the entire plate could be removed by simply reheating the PTS material. This process is generally easier and less labor intensive than cutting and grinding welds. Lastly, initial installation of a rigid member to a boat hull is simpler and less labor intensive than, for example, continuously welding the rigid member to the boat hull.

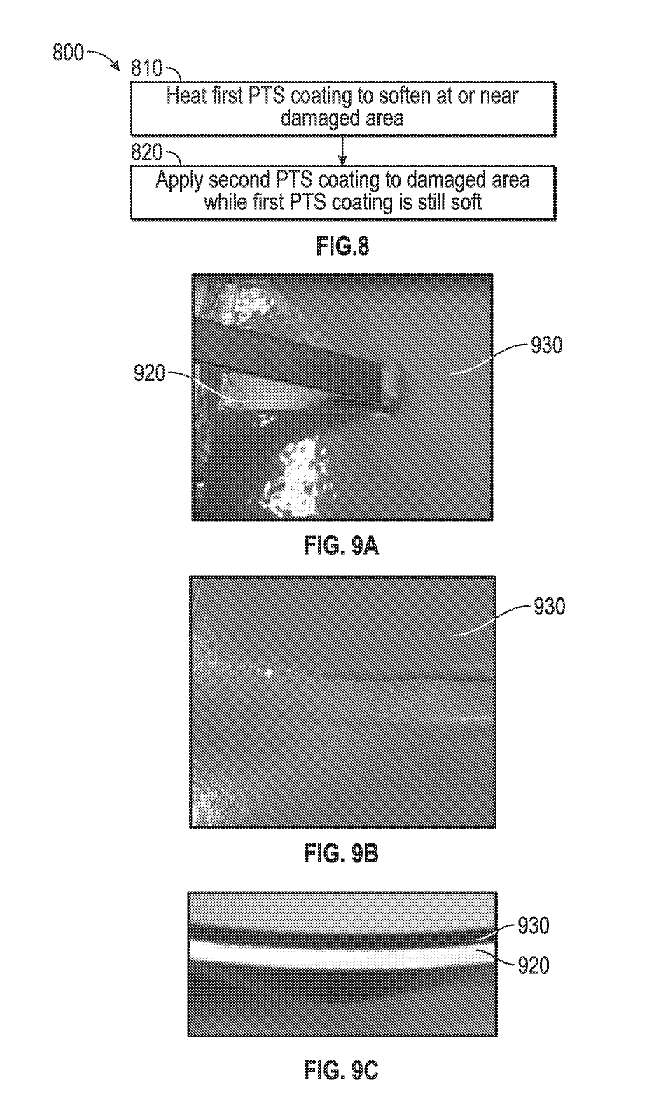

According to another aspect of the present disclosure, a method for repairing a boat hull is provided. The method includes the use of a PTS coating to repair a boat hull including an existing PTS coating layer with a damaged section (e.g., a scrape, a dent, etc.). For example, FIG. 8 illustrates a method 800 for repairing a damaged PTS coating layer on a boat hull according to one implementation. The boat hull includes a first PTS coating layer including a damaged area, such as a scrape or dent. The first PTS coating can be heated so as to soften the material at or near the damaged area (810). While the first PTS coating is still soft, a second PTS coating can be applied to the damaged area such that the second PTS coating melts into and blends with the first PTS coating (820). In this way, the second PTS coating provides a substantially seamless, integral repair of the damaged area of on the boat hull. In some implementations, the second PTS coating can be applied using a hand-held applicator gun (e.g., applicator gun 10).

For example, FIGS. 9a-9b illustrate an example repair of a boat hull having a scraped, damaged section of a PTS coating. FIG. 9a shows a boat hull substrate 920 including a first PTS coating 930. The first PTS coating 930 was reheated and is shown being scrapped using a flat metal scraping tool to simulate a scraping incident or damage to the boat hull, such as when a boat hull impacts a rock or other rigid object. As shown in FIG. 9b, the scraping with the flat metal scraping tool leads to a panel/substrate that appears damaged from a scraping incident. The scrape in the first PTS coating 930 is repairable through re-heating the first PTS coating and through applying a second PTS coating, as described above with respect to the method of FIG. 8. The second PTS coating melts into and blends with the first PTS coating and cools into a filled, substantially seamless integral repair.

According to another example, FIG. 9c illustrates an example repair of an aluminum boat hull having a dented, damaged section in a first PTS coating. As shown in FIG. 9c, a dented piece of ¼ thick aluminum plate 920 contains a first PTS coating 930. The dent was repaired on the outside by re-heating the first PTS coating 930 and applying a second PTS coating that fused with the first PTS coating 920 and cooled into a filled, integral repair. By contrast, similar repairs made to boat hulls or substrates treated with the above-described non-PTS coatings entail welding an additional plate over the dent, and then grinding the plate to contour and blend the plate into the surface of the hull material. This is both time consuming and can be difficult to provide a seamless, integral repair.

On the other hand, the use of PTS coatings is particularly advantageous, because the thermoplastic properties of the PTS coating allow it to be softened after initial application on the boat hull through the application of heat, thereby allowing for quick repair in the field. As explained above, the PTS coating can be repaired by adding heat and additional PTS coating material to form a substantially seamless, integral repair. Furthermore, the PTS coating may be removed by heating the coating until it becomes easy to scrape off of the substrate, and then scraping the PTS coating off of the substrate completely. By contrast, alternative chemical coatings (e.g., a two-part epoxy coating, a two-part urea coating, a two-part urethane coating, an adhesive sealant or coating that air dries or requires a chemical reaction such as a catalyst, etc.) cannot be re-heated and removed from the substrate to allow for quick, effective repairs in the field.

According to various implementations, the PTS coating material includes a powder formulation having a uniform powder composition. In some implementations, the uniform powder may comprise one or more thermoplastic resins, such as ethylene-acrylic, acid copolymer, ethylene-methacrylic acid copolymer, or ethylene-vinyl acetate copolymer, with melting temperature of between about 60° C. and about 100° C. In some implementations, the thermoplastic resin is a thermoplastic polyolefin resin. In some implementations, the uniform powder may include fillers, fibers, pigments, cross-linkers flow agents, bubble-release agents, antioxidants, heat stabilizers, ultraviolet (UV) light absorbers, UV light blockers, flame-retardant agents, corrosion-resistant agents, gloss agents, electrically conductive agents, clarifying agents, blowing agents, compatibilizing agents, or the like.

In some implementations, the thermoplastic resin, or resins, may have a number average molecular weight of between about 15,000 and about 200,000 and a melt flow viscosity higher than about 30 grams per 10 minutes. Prior to grinding and sieving the finished powders, all components of the formulation may be intimately compounded by conventional means at temperatures of at least 10° C. higher than the highest melting temperature of the different thermoplastic resins, but at least 10° C. lower than the degradation temperature of the lowest melting temperature thermoplastic resin. In some implementations, the thermoplastic powder has an average size of between about 50 μm and about 250 μm, and a density of between about 0.95 g/cm3 and about 1.8 g/cm3. In some implementations, the thermoplastic powder flows and forms a continuous film at temperatures in the range of about 90° C. to about 150° C.

In some other implementations, the thermoplastic resins may include polypropylene and/or propylene copolymers, such as propylene anhydride copolymer, with melting temperatures of between about 140° C. and about 170° C. In some implementations, the powder may include fillers, fibers, pigments, cross-linkers flow agents, bubble-release agents, antioxidants, heat stabilizers, ultraviolet (UV) light absorbers, UV light blockers, flame-retardant agents, corrosion-resistant agents, gloss agents, electrically conductive agents, clarifying agents, blowing agents, compatibilizing agents, or the like. In some implementations, the thermoplastic powder has an average size of between about 50 μm and about 250 μm, and a density of between about 0.95 g/cm3 and about 1.8 g/cm3. In some implementations, the thermoplastic powder flows and forms a continuous film at temperatures in the range of about 160° C. to about 200° C.

In some other implementations, a powder coating formulation or system includes a substantially uniform powder comprising one or more thermoplastic polyurethane resins, such as, but not limited to, polyether based polyurethanes and polyester based polyurethanes. In some implementations, the thermoplastic polyurethane resin has a melting temperature of between about 170° C. and about 200° C. In some implementations, the thermoplastic polyurethane resin may include fillers, fibers, pigments, cross-linkers flow agents, bubble-release agents, antioxidants, heat stabilizers, ultraviolet (UV) light absorbers, UV light blockers, flame-retardant agents, corrosion-resistant agents, gloss agents, electrically conductive agents, clarifying agents, blowing agents, compatibilizing agents, or the like. In some implementations, the thermoplastic powder has an average size of between about 50 μm and about 250 μm, and a density of between about 0.95 g/cm3 and about 1.8 g/cm3. In some implementations, the thermoplastic powder flows and forms a continuous film at temperatures in the range of about 190° C. to about 220° C.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Having described certain implementations, it will now become apparent to one of skill in the art that other implementations incorporating the concepts of the disclosure may be used. Therefore, the disclosure should not be limited to certain implementations, but rather should be limited only by the spirit and scope of the following claims.

What is claimed is:

1. A method for protecting a boat hull, comprising:
separately applying a first polymer thermal spray coating to a surface of a boat hull and to a rigid member;
placing the rigid member at a desired location on the surface of the boat hull; and
heating the rigid member such that the first polymer thermal spray coating adhesively bonds the rigid member to the surface of the boat hull.

2. The method of claim 1, further comprising applying a second polymer thermal spray coating to both the rigid member and the boat hull to encapsulate the rigid member on the boat hull.

3. The method of claim 2, wherein the rigid member is a doubler plate.

4. The method of claim 3, wherein the doubler plate is placed on at least one of a keel, a bow, or a transom corner of the boat hull before heating and applying the second polymer thermal spray coating.

5. The method of claim 2, wherein at least one of the first and second polymer thermal spray coatings comprises a substantially uniform powder including at least one of a thermoplastic resin or a thermoplastic polyurethane resin.

6. The method of claim 2, wherein at least one of the first and second polymer thermal spray coatings has a thickness of between about 0.01 inches and about 0.5 inches.

7. A method for protecting a boat hull, comprising:
separately applying a first polymer thermal spray coating to a surface of a boat hull and to a rigid member;
placing the rigid member at a desired location on the surface of the boat hull; and
applying a second polymer thermal spray coating to both the rigid member and the boat hull to encapsulate the rigid member on the boat hull.

8. The method of claim 7, wherein applying the second polymer thermal spray coating acts to bond the rigid member to the boat hull.

9. The method of claim 8, wherein the rigid member is a strake angle piece.

10. The method of claim 9, wherein the strake angle piece is placed on a hull plank of the boat hull before applying the second polymer thermal spray coating.

11. The method of claim 10, wherein the second polymer thermal spray coating conforms to the strake angle piece and the hull plank, and wherein the second polymer thermal spray coating adhesively bonds the strake angle piece to the hull plank and seals the interface therebetween.

12. The method of claim 7, further comprising heating the rigid member such that the first polymer thermal spray coating adhesively bonds the rigid member to the surface of the boat hull before applying the second polymer thermal spray coating.

13. The method of claim 12, wherein the rigid member is a doubler plate.

14. The method of claim 13, wherein the doubler plate is placed on at least one of a keel, a bow, or a transom corner of the boat hull before heating and applying the second polymer thermal spray coating.

15. The method of claim 7, wherein the boat hull is made from at least one of aluminum, steel, or a composite material.

16. The method of claim 7, wherein at least one of the first and second polymer thermal spray coatings comprises a substantially uniform powder including at least one of a thermoplastic polyolefin resin or a thermoplastic polyurethane resin.

17. The method of claim 7, wherein applying the second polymer thermal spray coating to the rigid member and the boat hull creates a watertight seal therebetween.

18. A method for repairing a boat hull, comprising:
providing a boat hull including a first polymer thermal spray coating with a damaged area;
heating the first polymer thermal spray coating at or near the damaged area to soften the first polymer thermal spray coating; and
applying, while the first polymer thermal spray coating is still soft, a second polymer thermal spray coating to the damaged area such that the second polymer thermal spray coating melts into and blends with the first polymer thermal spray coating to provide a substantially seamless, integral repair.

19. The method of claim 18, wherein the boat hull is made from at least one of aluminum, steel, or a composite material.

20. The method of claim 18, wherein at least one of the first and second polymer thermal spray coatings comprises a substantially uniform powder including at least one of a thermoplastic polyolefin resin or a thermoplastic polyurethane resin.
